(19) United States
(12) Patent Application Publication
(10) Pub. No.: US 2026/0337420 A1
(43) Pub. Date: Oct. 29, 2026

(54) FIBERGLASS OVERLAY WITH INTUMESCENT FIRE RETARDANT COATING

(71) Applicant: ARCLIN USA LLC, Alpharetta, GA (US)

(72) Inventors: Christoph Frieder Schauwecker, Lowell, OR (US); Daniel Davis, Eugene, OR (US); Teong Tan, Alpharetta, GA (US); Guillermo Velarde, Cary, NC (US); Darren Riedlinger, Springfield, OR (US)

(73) Assignee: ARCLIN USA LLC, Alpharetta, GA (US)

(21) Appl. No.: 19/120,543

(22) PCT Filed: Oct. 12, 2023
(86) PCT No.: PCT/US2023/076697

§ 371 Date: Apr. 11, 2025

Related U.S. Application Data
(60) Provisional application No. 63/379,560, filed on Oct. 14, 2022.

(51) Int. Cl. C09D 5/18; C09D 7/61; D06M 11/72; D06M 11/74; D06M 11/76; D06M 11/82; D06M 15/263; D06M 101/00

(52) U.S. Cl. CPC C09D 5/185; C09D 7/61; D06M 11/72; D06M 11/74; D06M 11/76; D06M 11/82; D06M 15/263; D06M 2101/00; D06M 2200/30; D10B 2101/06; D10B 2403/02421; D10B 2403/0243

(57) ABSTRACT

A fire retardant overlay is described for use in providing fire resistance to a substrate, and methods for preparing the same. The overlay contains an intumescent coating layer comprising an expandable graphite and a polymeric binder and a fiberglass layer comprising a polymeric binder, wherein the polymeric binder of the intumescent coating layer may be the same or different from the polymeric binder of the fiberglass layer. The overlay has the following feature(s) (A) and/or (B):(A) wherein the expandable graphite has an activation temperature which is higher than the crossover temperature of the polymeric binder in the intumescent coating layer; and/or (B) said fiberglass layer has a bottom half and a top half, and the bottom half has a higher concentration of polymeric binder than the top half, in addition to the intumescent coating layer being in contact with the top half of the fiberglass layer.

### TECHNICAL FIELD

The present disclosure relates to fiberglass overlays containing intumescent fire resistant and flexible coatings. The disclosure relates to overlays for use as fire retardant barriers on construction surfaces and materials, as well as to methods for protecting construction surfaces and materials, and laminates made from these materials.

### BACKGROUND

Coating systems have been used for many years to provide fire protection to combustible wood building materials. Current fire retardant products require a coating that is typically based on ammonium polyphosphate or magnesium oxide that release water and forms a barrier. On the other hand, fire retardant intumescent products have chemical-based coatings which react when exposed to heat to form a voluminous insulating carbonized foam char on the surface to protect the material against the heat of the fire or release water upon heating, cooling the surface while also providing a physical barrier. These traditional fire retardant intumescent coated assemblies are thick, heavy, brittle, difficult to manufacture, require specific handling, and typically still require a gypsum based board on the outside of building constructions for fire retardancy.

UK patent application 2053798A discloses a flame retardant laminate comprising a flammable substrate, a metal foil adhered to a face of the substrate, and a resin-saturated fibrous web adhered to the foil, the foil being between the fibrous web and the substrate. The web is formed predominantly of fire resistant fibers, such as glass, ceramic, phenolic, carbon, and asbestos. The resin saturating the web is selected from among vinyl compounds, acrylics, polyesters, polyamides, polyimides, melamines, phenolics, urea formaldehyde resins, epoxies, modified cellulosics, and the like. The foil may be of any suitable metal, such as aluminum, having a thickness up to several mils. The substrate may be a construction material such as lumber, plywood, pressed board, chip board, hard board, or an insulative plastic foam.

U.S. Pat. No. 8,458,971 teaches fire-resistant wood products and formulations for fire-resistant coatings. In some embodiments, the disclosure includes a fire-resistant coating comprising an aromatic isocyanate (present in a quantity ranging from about 15% to about 39% by weight of the formulation), castor oil (present in a quantity ranging from about 37% to about 65% by weight of the formulation), and intumescent particles (present in a quantity ranging from about 1% to about 40% by weight of the formulation). Further aspects are directed towards materials such as wood products coated with fire-resistant coatings according to embodiments of the disclosure.

There is a need for a fire retardant assembly that is thinner, lighter in weight, less brittle, faster and easier to manufacture, and that requires less materials and resources for final building construction.

### SUMMARY

In an aspect, the present disclosure relates to a fire retardant overlay for use in providing fire resistance to a substrate, said overlay comprising:
an intumescent coating layer comprising at least one expandable graphite and at least one polymeric binder,
a fiberglass layer comprising at least one polymeric binder,
said polymeric binder of the intumescent coating layer may be the same or different from the polymeric binder of the fiberglass layer, said overlay having the following feature(s) (A) and/or (B):
(A) wherein the expandable graphite has an activation temperature which is higher than the crossover temperature of the polymeric binder in the intumescent coating layer; and/or
(B) said fiberglass layer having a bottom half and a top half, and the bottom half has a higher concentration of polymeric binder than the top half, wherein the intumescent coating layer is in contact with the top half of the fiberglass layer.

In an aspect, the present disclosure relates to a method of forming a fire retardant overlay, said overlay comprising:
an intumescent coating layer comprising at least one expandable graphite and at least one polymeric binder,
a fiberglass layer comprising at least one polymeric binder,
said polymeric binder of the intumescent coating layer may be the same or different from the polymeric binder of the fiberglass layer,
said method comprising the following feature(s) (A) and/or (B)
(A) a step of combining an expandable graphite having an activation temperature which is higher than the crossover temperature of the polymeric binder in the intumescent coating layer; and/or
(B) said fiberglass layer having a bottom half and a top half, and filling a fiberglass sheet from a bottom surface to form the fiberglass layer so that the bottom half of the fiberglass layer has a higher concentration of the total polymeric binder than the top half, applying an intumescent coating composition to a top surface of the fiberglass layer so that the intumescent coating layer is in contact with the top half of the fiberglass layer.

In each of the foregoing embodiments, the polymeric binder of the intumescent coating layer may be a vinyl polymer selected from the group consisting of vinyl acrylics, butyl, copolymers of acrylic acid ester and styrene, vinyl acetate, vinyl acrylic-vinyl versatate, vinyl acetate-vinyl versatate, polyvinylchloride-acrylic copolymers, carboxylated vinylidene chloride, polyvinylidene chloride acrylic copolymers, vinylchloride-ethylene, acrylate-acrylonitrile, and mixtures thereof; or the vinyl polymer is styrenated acrylates, vinyl acrylic-vinyl versatate, and vinyl acetate-vinyl versatate.

In each of the foregoing embodiments, the vinyl polymer may be present in the intumescent coating layer in an amount to provide at least 1 wt. %, or 1 wt. % to 40 wt. %, or 3 wt. % to 25 wt. %, or 10 wt. % to 20 wt. % based on a total dry weight of the intumescent coating layer.

In each of the foregoing embodiments, the intumescent coating layer may further comprise a boron-containing compound; or a barium borate, barium metaborate, zinc borate or zinc metaborate.

In each of the foregoing embodiments, the intumescent coating layer may further comprise a boron-containing compound present in an amount to provide a boron concentration in a range of greater than 0 wt. % to 2 wt. % based on total dry weight of the intumescent coating layer.

In each of the foregoing embodiments, the intumescent coating layer may further comprise a boron-containing compound in a concentration of at least 0.1 wt. %, or 3 wt. % to 15 wt. %, or 6 wt. % to 9 wt. % based on the total dry weight of the intumescent coating layer.

In each of the foregoing embodiments, the intumescent coating layer may further comprise a charring agent; or a charring agent comprising a phosphorous-containing compound; or a charring agent comprising an ammonium phosphate, amine phosphate, melamine phosphate, triphenyl phosphate, monoammonium phosphate, ammonium polyphosphate, and combinations thereof; or a charring agent which is ammonium polyphosphate (APP).

In each of the foregoing embodiments, the intumescent coating layer may further comprise a phosphorous-containing compound in an amount of 1 wt. %-30 wt. %; or 5 wt. %-23 wt. %; or 9 wt. %-13 wt. % based on the dry weight of the intumescent coating layer.

In each of the foregoing embodiments, the expandable graphite may have a mean or average size, expressed as the D 50, in a range of from about 30 μm to about 1.5 mm, or from about 50 μm to about 1.0 mm, or from about 180 μm to about 850 μm, or at least 30 μm, or at least 44 μm, or at least 180 μm, or at least 300 μm, or at most 1.5 mm, or at most 1.0 mm, or at most 850 μm, or at most 600 μm, or at most 500 μm, or at most 400 μm.

In each of the foregoing embodiments, the expandable graphite may have a particle size of 32 mesh, 50 mesh, 80 mesh, 100 mesh, 150 mesh, −100 mesh, −200 mesh, −325 mesh or mixtures thereof.

In each of the foregoing embodiments, there are two or more expandable graphites in the intumescent coating layer; or there are three or more expandable graphites in the intumescent coating layer.

In each of the foregoing embodiments, the expandable graphite may have a temperature of activation in the range of 165 °C to 300 °C, or 180 °C to 300 °C, or in the range of 190 °C to 260 °C, or in the range of 200 °C to 220 °C.

In each of the foregoing embodiments, the expandable graphite may be in a concentration of at least 10 wt. %, or 10 wt. % to 25 wt. %, or 19 wt. % to 23 wt. % based on the total dry weight of the intumescent coating layer.

In each of the foregoing embodiments, the intumescent layer may have a thickness of up to 1.50 mm, or up to 1.00 mm, or 0.1 mm to 1.50 mm, or 0.1 mm to 1.00 mm, or less than 0.7 mm, or 0.3 mm to 0.6 mm, or 0.4 mm to 0.55 mm; and the fiberglass layer may have a thickness of less than 0.5 mm, or 0.2 mm to 0.5 mm, or 0.25 mm to 0.4 mm; or wherein the thickness of the intumescent layer may be at least 50 microns thicker than the fiberglass layer.

In each of the foregoing embodiments, the fiberglass layer may be formed from a fiberglass sheet, fiberglass mat, scrim, loose weaves or fiberglass mesh comprising a plurality of nonwoven glass fibers and a composition comprising a binder and said composition may be at least partially cured.

In each of the foregoing embodiments, the binder for the fiberglass layer can be selected from polyvinyl resins or condensation-polymers; or polyvinyl acetate, polyvinyl butyral, polyvinyl alcohol, polystyrene resins; acrylic ester resins and methacrylic ester resins, phenol-aldehydes, urea-aldehydes, melamine-aldehydes, and condensation-polymers of furan or polyurethane resins; or styrene acrylic resins, cyanoacrylates, polyisobutylene polyamide, carlonidene polymers (Coarmarone-idene polymers), silicone synthetic resins; or urea formaldehyde resin or an acrylic resin.

In each of the foregoing embodiments, the binder for the fiberglass layer can be present in an amount of less than 15 wt. %, or 1 wt. % to 12 wt. %, or 3 wt. % to 10 wt. % based on the total weight of the fiberglass layer.

In each of the foregoing embodiments, the fiberglass layer can comprise clay selected from montmorillonite clay, vermiculite, mica, talc, bentonite clay, kaolin clay, zeolite, china clay and mixtures thereof.

In each of the foregoing embodiments, the fiberglass layer can comprise a metal carbonate; or, sodium carbonate, potassium carbonate, magnesium carbonate or calcium carbonate.

In each of the foregoing embodiments, the bottom half of the fiberglass layer can have more types of clay than the top half.

In each of the foregoing embodiments, the bottom half of the fiberglass layer can have more types of metal carbonate than the top half.

In each of the foregoing embodiments, the bottom half of the fiberglass layer can have a concentration of total polymeric binder which is at least 0.1 wt. %, or at least 0.5 wt. % or at least 1 wt. % higher than the top half, based on the total weight of the fiberglass layer.

In each of the foregoing embodiments, the bottom half of the fiberglass layer can have a concentration of clay and/or metal carbonate which is at least 0.1 wt. %, or at least 0.5 wt. % or at least 1 wt. % higher than the top half, based on the total weight of the fiberglass layer.

In each of the foregoing embodiments, the fiberglass layer can comprise clay present in an amount of at least 5 wt. %, or 5 wt. % to 40 wt. %, or 10 wt. % to 35 wt. %, or 15 wt. % to 30 wt. % based on the total dry weight of fiberglass layer.

In each of the foregoing embodiments, the fiberglass layer can comprise metal carbonate present in an amount of at least 5 wt. %, or 5 wt. % to 80 wt. %, or 20 wt. % to 75 wt. %, or 35 wt. % to 65 wt. % based on the total dry weight of the fiberglass layer.

In each of the foregoing embodiments, the intumescent coating layer can be formed from an intumescent coating composition and a portion of the intumescent coating composition penetrates the upper half of the fiberglass layer when the intumescent coating composition is applied.

In each of the foregoing embodiments, the total weight of the fiberglass layer can have an increase of 575 wt. % to 800 wt. % of its original weight after the fiberglass layer has been filled from the bottom surface with the polymeric binder, and optionally, clay and metal carbonate, and can have a Gurley porosity of greater than 300 seconds/300 cm³ of air using ISO test method 5636-5.

In each of the foregoing embodiments, the fiberglass layer which has been filled from the bottom surface can have a dry weight of 300 gsm to 700 gsm, or 350 gsm to 650 gsm, or 420 gsm to 600 gsm.

In each of the foregoing embodiments, the overlay can have a dry weight of 300 gsm to 1500 gsm, or 400 gsm to 1000 gsm, or 600 gsm to 900 gsm.

In each of the foregoing embodiments, the fiberglass layer can have glass fibers essentially continuously spread throughout the length and width of the fiberglass layer; or wherein the fiberglass layer can comprise nonwoven glass fibers.

In each of the foregoing embodiments, the intumescent coating layer can have a top surface which is black.

In an aspect, the disclosure relates to a fire retardant assembly comprising the fire retardant overlay of any one of the foregoing embodiments bonded to a substrate.

In each of the foregoing embodiments, two or more fire retardant overlays of the fire retardant assembly can be bonded to opposite sides of the same substrate.

In each of the foregoing embodiments, the fire retardant overlay of the fire retardant assembly can be bonded to the substrate with a fastener.

In each of the foregoing embodiments, the fastener can be a mechanical fastener or chemical fastener.

In each of the foregoing embodiments, the mechanical fastener can be staples, nails, screws, or the like; or staples, nails or screws.

In each of the foregoing embodiments, the chemical fastener can be an adhesive In each of the foregoing embodiments, the adhesive of the fire retardant overlay in the fire retardant assembly can have a weight of 10 gsm to 400 gsm, or 50 gsm to 300 gsm, or 100 gsm to 200 gsm.

In each of the foregoing embodiments, the substrate of the fire retardant assembly can be a panel of plywood, oriented strand board (OSB), medium density fiberboard (MDF), solid wood, member cut from solid wood (such as lumber and telephone poles), mass timber panel, particle board, a metal part, gypsum wall board, or a hybrid thereof.

In each of the foregoing embodiments, the substrate of the fire retardant assembly can be a panel having a thickness of 1 mm to 300 mm, 5 mm to 160 mm, 5 mm to 40 mm, or 8 mm to 20 mm.

In each of the foregoing embodiments, the fire retardant assembly can have a 1 hr to 2.5 hr fire rating using an ASTM E119 wall burn test.

In each of the foregoing embodiments, the substrate of the fire retardant assembly can be a wood panel, and the fire retardant assembly can further comprise a drywall layer, structural lumber, and insulation; or wherein the substrate is mass timber; or wherein the substrate is solid sawn wood behind which is the stud cavity and then on the other side of the stud cavity is drywall, OSB, plywood or more tongue and groove solid sawn wood boards; or wherein the substrate is a metal structural member and further comprising a column or metal sheet on the other side.

Additional details and advantages of the disclosure will be set forth in part in the description which follows, and/or may be learned by practice of the disclosure. The details and advantages of the disclosure may be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

FIG. 1 is a diagram of standard fire retardant assembly for a wall wherein two fire retardant overlays of this disclosure are bonded to opposite sides of the same substrate.

FIG. 2 is a micrograph cross section of an Intumescent Fire Retardant Engineered Wood Assembly with plywood substrate.

FIG. 3 is a micrograph cross section of an Intumescent Fire Retardant Engineered Wood Assembly with plywood substrate.

FIGS. 4A and 4B are photographs showing the filled side (bottom half side) of the fiberglass layer and the unfilled side (top half side) of the fiberglass layer, respectively.

FIGS. 5A and 5B are photographs showing the intumescent coated side and the opposite side which is the filled side (bottom side of fiberglass layer), respectively.

FIG. 6A is a graph showing the thermograms of comparative examples.

FIG. 6B is a graph showing the thermograms of inventive examples.

### DETAILED DESCRIPTION

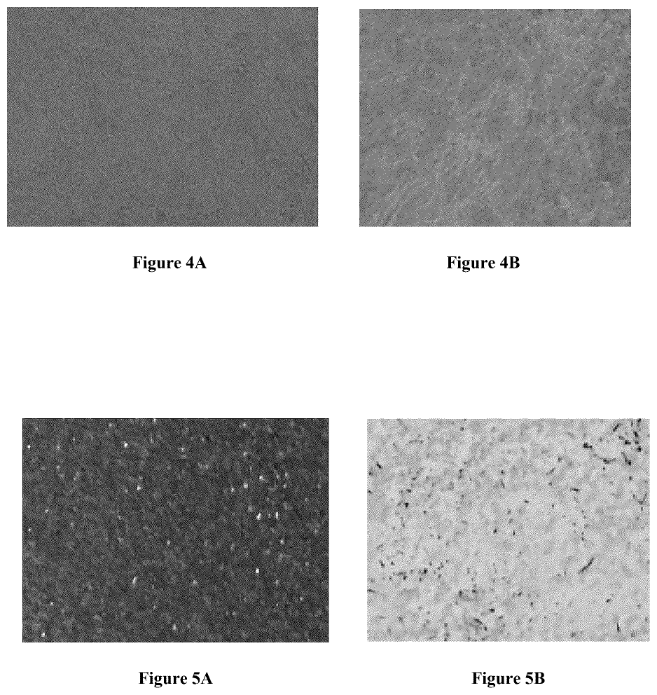

An aspect of the disclosure relates to a fire retardant overlay and a method for preparing the same. The fire retardant overlay can be made with a fiberglass sheet comprising glass fibers and at least partially cured binder comprising a polymeric binder. The fiberglass sheet can be further filled with a polymeric binder from the bottom side of the fiberglass sheet. The resulting fiberglass layer, prior to adding the intumescent coating layer, has a bottom half having a higher concentration of total polymeric binder than the top half. The photographs in FIGS. 4A-AB show the filled side (bottom half side) in FIG. 4A and the unfilled side (top half side) of sheet in FIG. 4B.

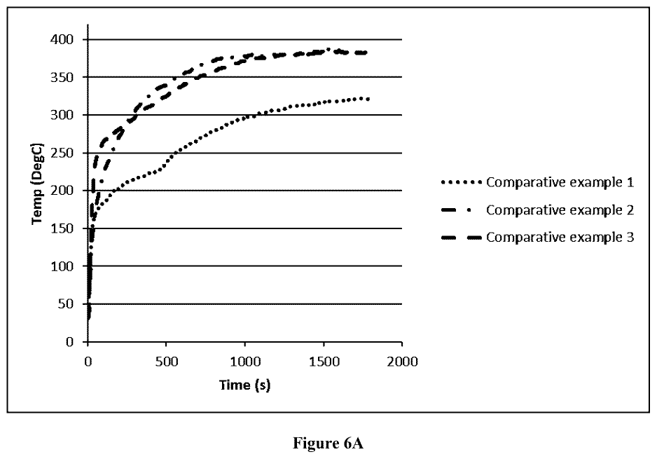

An intumescent coating composition is then applied to the top side of the fiberglass layer to form the fire retardant overlay of the disclosure. The photographs in FIGS. 5A-5B show the intumescent coated side is in FIG. 5A and the opposite side which is the filled side (bottom side of fiberglass sheet) in FIG. 5B.

The fire retardant overlay can be used to form a fire retardant assembly by gluing the surface of the filled side (bottom side) to the surface of a substrate, such as a board panel, with an adhesive, such as a two component polyurethane adhesive.

### OVERLAY

In one aspect, the disclosure relates to a fire retardant overlay for use in providing fire resistance to a substrate, said overlay comprising:
an intumescent coating layer comprising an expandable graphite and a polymeric binder,
a fiberglass layer comprising a polymeric binder,
said polymeric binder of the intumescent coating layer may be the same or different from the polymeric binder of the fiberglass layer, said overlay having the following feature(s) (A) and/or (B):
   (A) wherein the expandable graphite has an activation temperature which is higher than the crossover temperature of the polymeric binder in the intumescent coating layer; and/or
   (B) said fiberglass layer having a bottom half and a top half, and the bottom half has a higher concentration of total polymeric binder than the top half, wherein the intumescent coating layer is in contact with the top half of the fiberglass layer.

In another aspect, the disclosure relates to a method of forming a fire retardant overlay, said overlay comprising
an intumescent coating layer comprising an expandable graphite and a polymeric binder,
a fiberglass layer comprising a polymeric binder,
said polymeric binder of the intumescent coating layer may be the same or different from the polymeric binder of the fiberglass layer,
said method comprising the following feature(s) (A) and/or (B)
   (A) a step of combining an expandable graphite having an activation temperature which is higher than the crossover temperature of the polymeric binder in the intumescent coating layer; and/or
   (B) said fiberglass layer having a bottom half and a top half, and filling a fiberglass sheet from a bottom surface to form the fiberglass layer so that the bottom half of the fiberglass layer has a higher concentration of the total polymeric binder than the top half, applying an intumescent coating composition to a top surface of the fiberglass layer so that the intumescent coating layer is in contact with the top half of the fiberglass layer.

The intumescent coating layer can have a thickness of up to 1.00 mm, or 0.1 mm to 1.0 mm, or less than 0.7 mm, or 0.4 mm to 0.55 mm; and the fiberglass layer has a thickness of less than 0.5 mm, or 0.2 mm to 0.5 mm, or 0.25 mm to 0.4 mm.

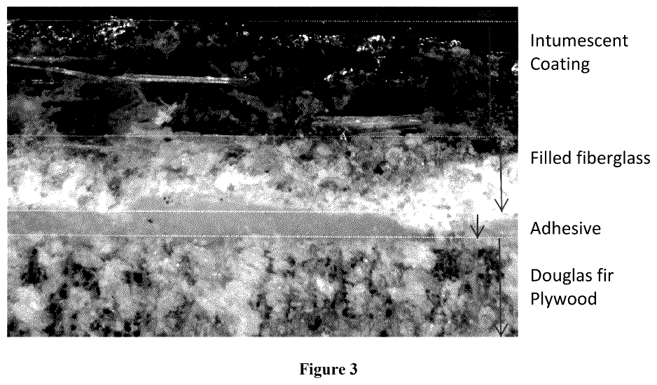

The determination of the thickness of each layer is explained referring to the micrograph of the cross section of the fire retardant assembly of FIG. 3 of the present disclosure. The fire retardant assembly includes a plywood substrate on the bottom, an adhesive layer on top of the plywood substrate, a fiberglass layer on top of the adhesive layer and an intumescent coating layer on top of the fiberglass layer. The thickness is measured in a direction perpendicular to the top plane of the plywood substrate. As noted above, a portion of the intumescent coating composition penetrates the fiberglass layer when the intumescent coating composition is applied. The thickness of the fiberglass layer is the theoretical thickness of the fiberglass layer prior to the application of the intumescent coating composition and the adhesive. The thickness of the intumescent coating layer is the theoretical thickness as measured from the top of the fiberglass layer without consideration of the intumescent coating that has penetrated the top of the fiberglass layer.

### FIBERGLASS SHEET

The fiberglass layer can be made from a fiberglass sheet, fiberglass mat, scrim, loose weaves or fiberglass mesh. The fiberglass sheet can be made by combining glass fibers with a polymeric binder composition. (BINDER) The fiberglass sheet can be made by combining glass fibers with a first polymeric binder composition. The binder composition may include various polymeric materials such as polyvinyl acetate, polyvinyl butyral, polyvinyl alcohol, and other polyvinyl resins; polystyrene resins; acrylic ester resins and methacrylic ester resins, such as styrene acrylic resins; cyanoacrylates; and polyisobutylene polyamides, carlonidene products (Coarmarone-idene products), and various other synthetic resins such as silicone. Such binders are permanently soluble and fusible, so that they may be deformed by stress or soften when heated. The binders also include various phenol-aldehydes, urea-aldehydes, melamine-aldehydes, and other condensation-polymeric materials such as furan and polyurethane resins. These binders may be characterized by being converted to insoluble and infusible materials by either heat or catalysis. Preferably, the binder composition is a urea formaldehyde resin or an acrylic resin. This binder can be present homogeneously throughout the sheet.

The first polymeric binder composition for the fiberglass sheet can be present in an amount of less than 15 wt. %, or 1 wt. % to 12 wt. %, or 3 wt. % to 10 wt. %, based on the total weight of the fiberglass sheet.

(FIBERGLASS) The fiberglass sheet can be formed with fiberglass. As used herein, the terms “fiber,” “fibrous,” “fiberglass,” “fiber glass,” “glass fibers,” and the like refer to materials that have an elongated morphology exhibiting an aspect ratio (length to thickness) of greater than 100, generally greater than 500, and often greater than 1000. Indeed, an aspect ratio of over 10,000 is possible. Suitable fibers can be glass fibers, natural fibers, synthetic fibers, mineral fibers, ceramic fibers, metal fibers, carbon fibers, or any combination thereof. Illustrative glass fibers can include, but are not limited to, A-type glass fibers, C-type glass fibers, E-type glass fibers, S-type glass fibers, ECR-type glass fibers, wool glass fibers, and any combination thereof. The term “natural fibers,” as used herein refers to plant fibers extracted from any part of a plant, including, but not limited to, the stem, seeds, leaves, roots, or phloem. Illustrative natural fibers can include, but are not limited to, cotton, jute, bamboo, ramie, bagasse, hemp, coir, linen, kenaf, sisal, flax, henequen, and any combination thereof. Illustrative synthetic fibers can include, but are not limited to, synthetic polymers, such as polyester, polyamide, aramid such as Nomex® meta-aramid which is an aromatic polyamide, and any combination thereof. In at least one specific embodiment, the fibers can be glass fibers that are wet use chopped strand glass fibers (“WUCS”). Wet use chopped strand glass fibers can be formed by conventional processes known in the art. The WUCS can have a moisture content ranging from a low of about 5 wt. %, about 8 wt. %, or about 10 wt. % to a high of about 20 wt. %, about 25 wt. %, or about 30 wt. % based on the total weight of the WUCS composition.

Prior to using the fibers to make a fiberglass mat, the fibers may be allowed to age for a period of time. For example, the fibers can be aged for a period of a few hours to several weeks before being used to make a fiberglass product. For fiberglass mat products the fibers can typically be aged for about 3 to about 30 days. Ageing the fibers includes simply storing the fibers at room temperature for the desired amount of time prior to being used in making a fiberglass product.

In one or more embodiments, the method for binding loosely associated, non-woven mat or blanket of fibers can include, but is not limited to (1) contacting the fibers with the binder composition and (2) heating the curable binder composition to an elevated temperature, which temperature is sufficient to at least partially cure the binder composition. Preferably, the binder composition is cured at a temperature ranging from about 75 °C to about 300 °C, usually at a temperature between about 100 °C and up to a temperature of about 250 °C. The binder composition can be cured at an elevated temperature for a time ranging from about 1 second to about 15 minutes. The particular curing time can depend, at least in part, on the type of oven or other heating device design and/or production or line speed.

Fiberglass mats can be manufactured in a wet-laid or dry-laid process. In a wet-laid process, chopped bundles of fibers, having suitable length and diameter, can be introduced to an aqueous dispersant medium to produce an aqueous fiber slurry, known in the art as “white water.” The white water may typically contain about 0.5 wt % fibers. The fibers can have a diameter ranging from about 0.5 μm to about 30 μm and a length ranging from about 5 mm to about 50 mm, for example. The fibers can be sized or unsized and wet or dry, as long as the fibers can be suitably dispersed within the aqueous fiber slurry.

The introduction of one or more viscosity modifiers can reduce settling time of the fibers and can improve the dispersion of the fibers in the aqueous solution. The amount of viscosity modifier used can be effective to provide the viscosity needed to suspend the fibers in the white water as needed to form the wet laid fiber product. An example of a viscosity modifier/thickener is a polyurethane thickener such as Rheolate 278. The optional viscosity modifier(s) can be introduced in an amount ranging from a low of about 1 cP, about 1.5 cP, or about 2 cP to a high of about 8 cP, or about 12 cP, or about 15 cP (Brookfield Viscometer measured at 25 °C at 25 °C, as measured by a Brookfield viscometer with a small sample adapter such as a 10 mL adapter and the appropriate spindle to maximize torque such as a spindle no. 31.) For example, an optional viscosity modifier(s) can be introduced in an amount ranging from about 1 cP to about 12 cP, about 2 cP to about 10 cP, or about 2 cP to about 6 cP. The fiber slurry can also comprise carbon black.

The fiber slurry can comprise a defoamer. The defoamer may be one or more selected from the group consisting of BYK-028 from BYK, BYK-037 from BYK, BYK-055 from BYK, BYK-057 from BYK, BYK-070 from BYK and BYK-141 from BYK. The defoamer may be present in an amount of 0.001 wt. % to 1 wt. % based on the total weight of the fiber slurry.

The fiber slurry can comprise a dispersant. Any dispersant can be used so long that it improves the separation of the particles and prevents their settling or clumping. For instance, the dispersant can be one or more selected from DARVAN 7 (R. T. Vanderbilt Company) which is Sodium salt of polyacrylic acid, DARVAN 811 (R. T. Vanderbilt Company) which is Sodium polyelectrolyte, DARVAN 821A (R. T. Vanderbilt Company) which is Ammonium polyacrylate, DARVAN C (R. T. Vanderbilt Company) which is Ammonium polymethacrylate, DISPERBYK 190 (BYK-Chemie USA, Inc) which is High molecular weight copolymer, DISPERBYK 191 (BYK-Chemie USA, Inc), DISPERBYK 192 (BYK-Chemie USA, Inc), EDAPLANTM 492 (MÜNZING CHEMIE), SOLSPERSE 20000 (Avecia, Inc.) which is Polymeric alkoxylate, SOLSPERSE 27000 (Avecia, Inc.) which is Polymeric alkoxylate, SOLSPERSE 38500 (Avecia, Inc.) which is 2-methoxy-1-methethyl acetate, SOLSPERSE 41090 (Avecia, Inc.) which is Polymeric alkoxylate, SOLSPERSE 54000 (Avecia, Inc.) which is Polymeric Dispersant, TEGO DISPERS 740W (Degussa Tego) which is Non-ionic modified fatty acid derivative, TEGO DISPERS 750W (Degussa Tego), and TEGO DISPERS 760W (Degussa Tego). The dispersant can be present in an amount from 0.05 wt. % to 10 wt. %, based on the total weight of the fiber slurry.

In one or more embodiments, the fiber slurry can include from about 0.03 wt % to about 25 wt. % solids. The fiber slurry can be agitated to produce a uniform dispersion of fibers having a suitable consistency.

The fiber slurry, diluted or undiluted, can be introduced to a mat-forming machine that can include a mat forming screen, e.g., a wire screen or sheet of fabric, which can form a fiber product and can allow excess water to drain therefrom, thereby forming a wet or damp fiber mat. The fibers can be collected on the screen in the form of a wet fiber mat and excess water is removed by gravity and/or by vacuum assist. The removal of excess water via vacuum assist can include one or a series of vacuums.

In one or more embodiments, the drying and curing of the binder composition can be conducted in two or more distinct steps. For example, the composition may be first heated at a temperature and for a time sufficient to substantially dry but not to substantially cure the binder composition and then heated for a second time at a higher temperature and/or for a longer period of time to effect curing (cross-linking to a thermoset structure). Such a preliminary procedure, referred to as “B-staging,” may be used to provide a binder-treated product, for example, in roll form, which may at a later stage be fully cured, with or without forming or molding into a particular configuration, concurrent with the curing process. This makes it possible, for example, to use fiberglass products which can be molded and cured elsewhere.

The fiber mat product can be formed as a relatively thin product of about 0.25 mm (10 mils) to a relatively thick product of about 25.4 mm (1,000 mils). Depending on formation conditions, the density of the product can also be varied from a relatively fluffy low density product to a higher density of about 6 to about 10 pounds per cubic foot or higher. In one or more embodiments, the fiber mat product can have a basis weight ranging from a low of about 0.1 pound, about 0.5 pounds, or about 0.8 pounds per 100 square feet, to a high of about 3 pounds, about 4 pounds, or about 5 pounds per 100 square feet. For example, the fiber mat product can have a basis weight from about 0.6 pounds per 100 square feet to about 2.8 pounds per 100 square feet, about 1 pound per 100 square feet to about 2.5 pounds per 100 square feet, or about 1.5 pounds per 100 square feet to about 2.2 pounds per 100 square feet. In at least one specific embodiment, the fiber mat product can have a basis weight of about 1.2 pounds per 100 square feet, about 1.8 pounds per 100 square feet, or about 2.4 pounds per 100 square feet.

The fibers can represent the principal material of the non-woven fiber fiberglass mat. For example, 60 wt. % to about 90 wt. % of the fiberglass mat, based on the combined amount in weight of binder and fibers can be composed of the fibers. The binder composition can be applied in an amount such that the cured binder constitutes from about 1 wt. % to about 40 wt. % of the glass fiber mat. The first polymeric binder composition can be applied in an amount such that the cured binder constitutes a low from about 1 wt. %, or about 5 wt. %, or about 10 wt. % to a high of about 15 wt. %, or about 20 wt. %, or about 25 wt. % based on the total weight of the fiberglass mat.

The first polymeric binder composition can also include at least 0.1 wt. % of magnesium oxide (MgO) or alumina trihydrate (ATH), based on the total weight of the first polymeric binder composition.

(FILLING FROM BOTTOM SIDE OF FIBERGLASS SHEET WITH SECOND POLYMERIC BINDER COMPOSITION TO FORM THE FIBERGLASS LAYER) The fiberglass layer can be formed from a fiberglass sheet comprising glass fibers with a polymeric binder composition that is at least partially cured as discussed above, and then further filling the fiberglass sheet with a second polymeric binder composition from the bottom side of the fiberglass sheet. This results in the bottom half of the fiberglass layer having a higher concentration of total polymeric binder than the top half. Also, this can result in the bottom half of the fiberglass layer having a higher concentration of clay and/or metal carbonate than the top half. Preferably, the bottom half of the fiberglass layer has a concentration of total polymeric binder which is at least 0.1 wt. %, or at least 0.5 wt. % or at least 1 wt. % higher than the top half, based on the total weight of the fiberglass layer. Preferably, the bottom half of the fiberglass layer has a concentration of clay and/or metal carbonate which is at least 0.1 wt. %, or at least 0.5 wt. % or at least 1 wt. % higher than the top half, based on the total weight of the fiberglass layer.

(BINDER) The binder used in the second polymeric binder composition to form the fiberglass layer having a higher concentration of binder in the bottom half may be the same or different in type and/or amount from the binder used in making the fiberglass sheet. The binder used in the second polymeric binder composition may include various polymeric materials such as polyvinyl acetate, polyvinyl butyral, polyvinyl alcohol, and other polyvinyl resins; polystyrene resins; acrylic ester resins and methacrylic ester resins, such as styrene acrylic resins; cyanoacrylates; and polyisobutylene polyamides, carlonidene products (Coarmarone-idene products), and various other synthetic resins such as silicone. Such binders are permanently soluble and fusible, so that they may be deformed by stress or soften when heated. The binders also include various phenol-aldehydes, urea-aldehydes, melamine-aldehydes, and other condensation-polymeric materials such as furan and polyurethane resins. These binders may be characterized by being converted to insoluble and infusible materials by either heat or catalysis. Preferably, the binder composition is a urea formaldehyde resin or an acrylic resin.

The binder used in the second polymeric binder composition can be present in an amount of less than 15 wt. %, or 1 wt. % to 12 wt. %, or 3 wt. % to 10 wt. %, based on the total weight of the fiberglass layer.

The second polymeric binder composition can be, but is not necessarily, the same as the initial polymeric binder composition used to bind glass fibers in making the fiberglass sheet/mat.

The total weight of the fiberglass layer can increase to 575 wt. % and 800 wt. % of its original weight after the fiberglass layer has been filled from the bottom surface with the second polymeric binder composition that optionally includes clay and metal carbonate. After application of the second polymeric binder composition, the fiberglass layer can have a Gurley porosity of greater than 300 seconds/300 cm³ of air using ISO test method 5636-5.

The second polymeric binder composition can be applied in an amount such that the cured binder constitutes a low from about 1 wt. %, or about 5 wt. %, or about 10 wt. % to a high of about 15 wt. %, or about 20 wt. %, or about 25 wt. % based on a total weight of the fiberglass layer.

(CLAY) The second polymeric binder composition can comprise a clay selected from montmorillonite clay, vermiculite, mica, talc, bentonite clay, kaolin clay, zeolite, china clay and mixtures thereof. The clay in the second polymeric binder composition does not necessarily have to be the same type of clay used in the fiberglass sheet. The clay from the second polymeric binder composition can be present in an amount of at least 5 wt. %, or 5 wt. % to 40 wt. %, or 10 wt. % to 35 wt. %, or 15 wt. % to 30 wt. %, based on the total dry weight of fiberglass layer.

(METAL CARBONATE) The fiberglass layer can comprise a metal carbonate. The metal carbonate provides filling and sealing properties to the pores fiberglass mat, in addition carbonates aid in fire protection by lowering the temperature of the surrounding materials and releasing CO₂ quenching the fire. See for instance, Pondelak et al., “Improving the flame retardancy of wood using an eco-friendly mineralisation process” Green Chem. 2021, 23, 1130 (DOI:10.1039/DOGC03852K). The metal carbonate can include sodium carbonate, potassium carbonate, magnesium carbonate, calcium carbonate or mixtures thereof. Preferably, the metal carbonate is a calcium carbonate which is a medium particle size white calcitic marble.

The metal carbonate can be present in an amount of at least 5 wt. %, or 5 wt. % to 80 wt. %, or 20 wt. % to 75 wt. %, or 35 wt. % to 65 wt. %, based on the total dry weight of the fiberglass layer.

The ratio of clay, metal carbonate and binder can be varied in order to adjust the final porosity of the filled fiberglass layer.

The second polymeric binder composition can also include at least 0.1 wt. % of magnesium oxide (MgO) or alumina trihydrate (ATH), based on the total weight of the second polymeric binder composition.

(DEFOAMER) The second polymeric binder composition can comprise a defoamer which may be one or more selected from the group consisting of BYK-028 from BYK, BYK-037 from BYK, BYK-055 from BYK, BYK-057 from BYK, BYK-070 from BYK and BYK-141 from BYK. The defoamer may be in an amount of less than 1 wt. %, or 0.001 wt. % to 1 wt. % based on the total weight of the second polymeric binder composition.

(DISPERSANT) The second polymeric binder composition can comprise a dispersant. Any dispersant can be used so long that it improves the separation of the particles and prevents their settling or clumping. For instance, the dispersant can be one or more selected from DARVAN 7 (R. T. Vanderbilt Company) which is a sodium salt of polyacrylic acid, DARVAN 811 (R. T. Vanderbilt Company) which is Sodium polyelectrolyte, DARVAN 821A (R. T.

Vanderbilt Company) which is Ammonium polyacrylate, DARVAN C (R. T. Vanderbilt Company) which is Ammonium polymethacrylate, DISPERBYK 190 (BYK-Chemie USA, Inc) which is a high molecular weight copolymer, DISPERBYK 191 (BYK-Chemie USA, Inc), DISPERBYK 192 (BYK-Chemie USA, Inc), EDAPLAN™ 492 (MÜNZING CHEMIE), SOLSPERSE 20000 (Avecia, Inc.) which is Polymeric alkoxylate, SOLSPERSE 27000 (Avecia, Inc.) which is Polymeric alkoxylate, SOLSPERSE 38500 (Avecia, Inc.) which is 2-methoxy-1-methethyl acetate, SOLSPERSE 41090 (Avecia, Inc.) which is Polymeric alkoxylate, SOLSPERSE 54000 (Avecia, Inc.) which is Polymeric Dispersant, TEGO DISPERS 740W (Degussa Tego) which is a non-ionic modified fatty acid derivative, TEGO DISPERS 750W (Degussa Tego), and TEGO DISPERS 760W (Degussa Tego). The dispersant can be present in an amount from 0.05 wt. % to 10 wt. %, or 0.1 wt. % to 5 wt. % based on the total weight of the second polymeric binder composition. (ADDITIVES and SOLVENTS) The second polymeric binder composition can include additives, such as a viscosity modifier and carbon black. The amount of viscosity modifier used can be effective to thicken the second polymeric binder composition. An example of a viscosity modifier/thickener is a polyurethane thickener such as Rheolate 278.

The second polymeric binder composition can be formed with any solvent sufficient to dissolve and/or disperse the components. Preferably, the solvent is hydrophilic, such as ethanol, propanol, water and mixtures thereof. The amount of solvent can be up to 80 wt. %, or 1 wt. % to 50 wt. % or 5 wt. % to 25 wt. % based on the total weight of the second polymeric binder composition.

The fiberglass layer which has been filled from the bottom surface can have a dry weight of 300 gsm to 700 gsm, or 350 gsm to 650 gsm, or 420 gsm to 600 gsm.

### Intumescent Coating Layer

The intumescent coating layer is made from an intumescent coating composition comprising at least one type of expandable graphite. The expandable graphite is typically in flake form wherein upon exposure to high temperatures, the material expands and forms a graphite char. The expandable graphite may include an intercalant. The intercalant can degrade to produce gases that force the layer planes apart. The layer of expanded graphite forms an effective insulating “char” layer that protects the substrate from heat and air and interferes with the migration of decomposition products to the combustion zone. The binder resin for the intumescent coating layer ideally has a viscous, liquid-like transition in the same temperature region (150 °C-300 °C) that the graphite expands (i.e., the onset temperature) in order to allow for binder deformation to facilitate graphite expansion while maintaining adhesion of graphite to substrate. In an aspect, the expandable graphite having an activation temperature which is higher than the crossover temperature of the polymeric binder in the intumescent coating layer. Ideally, the binder resin comprises a vinyl copolymer resin.

The crossover temperature of the polymeric binder is the temperature where the elastic modulus (G″) becomes larger than the storage modulus (G′) such that tan (δ) (representation the ratio between G′ and G″) becomes larger than unity and occurring concomitant with a decrease in G′. The above represents a transition from a more solid-like to a more fluid-like viscoelastic behavior. The crossover temperature is determined using ASTM method D-4440 utilizing a parallel-plate oscillation rheology with an oscillation strain of 0.001 to 0.5% (dynamically adjusted), a oscillation frequency of 5Hz and a heating rate of 20 °C/min. Preferably, the expandable graphite has an activation temperature which is no more than 30 °C higher, or no more than 20 °C higher than the crossover temperature of the polymeric binder in the intumescent coating layer.

Without being bound to theory, it would be beneficial for the binder adhering the graphite to fiberglass layer to be able to flow or otherwise deform while the graphite is actively expanding. For example, with a rigid binder capable of withstanding only minimal strain before fracturing, the graphite would separate from the binder during expansion, potentially resulting in a weaker intumescent. However, if the binder instead exhibits viscous, liquid-like behavior throughout the temperature region of interest, it is possible to get some encapsulation of the expanded graphite flakes, potentially resulting in a more durable char.

The intumescent coating layer can have a top surface which is black. The color of this layer can be dominated by the color of the expandable graphite, which is black. The other components in the intumescent coating layer can also be black or can either be colorless or in such low concentration as to not significantly affect the overall color of the top surface.

(VINYL POLYMER BINDER RESIN) The vinyl polymer used as a binder resin in the intumescent coating layer can be selected from the group consisting of carboxylated styrene butadiene, styrene butadiene, styrenated acrylates, acrylics, vinyl acrylics, butyl, copolymers of acrylic acid ester and styrene, vinyl acetate, vinyl acrylic-vinyl versatate, vinyl acetate-vinyl versatate, polyvinylchloride-acrylic copolymers, carboxylated vinylidene chloride, polyvinylidene chloride acrylic copolymers, vinylchloride-ethylene, natural rubber, chloroprene, acrylate-acrylonitrile, and mixtures thereof; or the latex polymer is styrenated acrylates, vinyl acrylic-vinyl versatate, or vinyl acetate-vinyl versatate.

The fire retardant overlay can have the vinyl polymer present in the intumescent coating layer an amount at least 10 wt. %, or 10 wt. % to 50 wt. %, or 15 wt. % to 35 wt. %, or 20 wt. % to 30 wt. % based on a total weight of the intumescent coating layer.

(EXPANDABLE GRAPHITE) The expandable graphite can have an activation temperature which is higher than the crossover temperature of the polymeric binder in the intumescent coating layer. Commercially available examples of expandable graphite include HPMS Expandable Graphite (HP Materials Solutions, Inc., Woodland Hills, Calif.), Expandable Graphite Grades 1721 (Asbury Carbons, Asbury, N.J.) and GrafGuard® 180-60N, 200-100N, 210-140N, 220-50N and 250-50N (NeoGraf™ Solutions, Lakewood, Ohio). Other commercial grades contemplated as useful include 1722, 3393, 3577, 3626, and 1722HT (Asbury Carbons, Asbury, N.J.). The expandable graphite may be washed and neutralized with an acid, such as sulfuric acid, The expandable graphite may have a mean or average size, expressed as the D50, in the range from about 30 μm to about 1.5 mm, in other embodiments from about 50 μm to about 1.0 mm, and in other embodiments from about 180 μm to about 850 μm. In certain embodiments, the expandable graphite may have a mean or average particle size of at least 30 μm, in other embodiments at least 44 μm, in other embodiments at least 180 μm, and in other embodiments at least 300 μm. In one or more embodiments, expandable graphite may have a mean or average size of at most 1.5 mm, in other embodiments at most 1.0 mm, in other embodiments at most 850 um, in other embodiments at most 600 μm, in yet other embodiments at most 500 μm, and in still other embodiments at most 400 μm.

The expandable graphite may have a particle size of 32 mesh, 50 mesh, 80 mesh, 100 mesh, 150 mesh, -100 mesh, -200 mesh, or -325 mesh. Useful expandable graphite includes GrafGuard® 220-50N having an onset temperature of 220 °C and a particle sizing 50 mesh.

The expandable graphite may have a carbon content in the range from about 70 wt. % to about 99 wt. %. In certain embodiments, the expandable graphite may have a carbon content of at least 80 wt. %, in other embodiments at least 85 wt. %, in other embodiments at least 90 wt. %, in yet other embodiments at least 95 wt. %, in other embodiments at least 98 wt. %, and in still other embodiments at least 99 wt. % carbon based on the total weight of the expandable graphite. In one or more embodiments, the expandable graphite may have a sulfur content in the range from about 0 wt. % to about 8 wt. %, in other embodiments from about 0.01 wt. % to about 8 wt. %, in other embodiments from about 2.6 wt. % to about 5.0 wt. %, and in other embodiments from about 3.0 wt. % to about 3.5 wt. % based on the total weight of the expandable graphite. In certain embodiments, the expandable graphite may have a sulfur content of at least 0 wt. %, in other embodiments at least 0.01 wt. %, in other embodiments at least 2.6 wt. %, in other embodiments at least 2.9 wt. %, in other embodiments at least 3.2 wt. %, and in other embodiments 3.5 wt. %. In certain embodiments, the expandable graphite may have a sulfur content of at most 8 wt. %, in other embodiments at most 5 wt. %, in other embodiments at most 3.5 wt. % based on the total weight of the expandable graphite.

The expandable graphite may be present in a concentration of at least 10 wt. %, or 10 wt. % to 35 wt. %, or 15 wt. % to 25 wt. % based on the total weight of the intumescent coating layer.

The expandable graphite may have an expansion ratio (cc/g) in the range from about 10:1 to about 500:1, in other embodiments at least 20:1 to about 450:1, in other embodiments at least 30:1 to about 400:1, in other embodiments from about 50:1 to about 350:1. In certain embodiments, the expandable graphite may have an expansion ratio (cc/g) of at least 10:1, in other embodiments at least 20:1, in other embodiments at least 30:1, in other embodiments at least 40:1, in other embodiments at least 50:1, in other embodiments at least 60:1, in other embodiments at least 90:1, in other embodiments at least 160:1, in other embodiments at least 210:1, in other embodiments at least 220:1, in other embodiments at least 230:1, in other embodiments at least 270:1, in other embodiments at least 290:1, and in yet other embodiments at least 300:1. In certain embodiments, the expandable graphite may have an expansion ratio (cc/g) of at most 350:1, and in yet other embodiments at most 300:1.

In one or more embodiments, the expandable graphite may have a pH in the range from about 1 to about 10; in other embodiments from about 1 to about 6; and in yet other embodiments from about 5 to about 10. In certain embodiments, the expandable graphite may have a pH in the range from about 4 to about 8. In one or more embodiments, the expandable graphite may have a pH of at least 1, in other embodiments at least 4, and in other embodiments at least 5. In certain embodiments, the expandable graphite may have a pH of at most 10, in other embodiments at most 8, in other embodiments at most 6.5, in other embodiments at most 6, and in other embodiments at most 5. The pH may be measured using an Apera Instruments, LLC-AI221 SX610 Waterproof pH Pen Tester (+0.1 pH Accuracy, 0 -14.0 pH Range, Suitable for Test Tube Testing, Replaceable Probe.) The expandable graphite preferably has a temperature of activation in the range of 180 °C to 300 °C, preferably in the range of 190 °C to 260 °C, more preferably in the range of 200 °C to 220 °C. The temperature of activation may be interchangeably referred to as the onset temperature or expansion temperature and typically refers to the temperature at which expansion of the graphite starts.

A common method for manufacturing particles of intercalated graphite is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. Although less preferred, the intercalation solutions may contain metal halides such as ferric chloride, and ferric chloride mixed with sulfuric acid, or a halide, such as bromine as a solution of bromine and sulfuric acid or bromine in an organic solvent. The quantity of intercalation solution may range from about 20 to about 150 pph and more typically about 50 to about 120 pph.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed.

Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution will be aqueous and will preferably contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After the flakes are intercalated, any excess solution is drained from the flakes and the flakes are washed, specifically water-washed.

After being water-washed, a surfactant is then added to the intercalated graphite flakes, such as by coating, spraying or applying the surfactant on the flakes. By surfactant is meant a surface-active agent capable of reducing interfacial tension between a liquid and a solid, such as a wetting agent. Particularly useful surfactants include hexadecanol; lignins, such as lignin sulfonates like sodium lignosulfonate, commercially available as Marasperse N-22 from Lignotech USA, Inc. of Rothschild, Wis.; glycols, such as nonylphenol polyethylene glycol ether, commercially available as Tergitol NP-10 from Union Carbide Chemicals and Plastics Company Inc. of Danbury, Conn.; and organosilicones like polyalkyleneoxide modified polydimethylsiloxane, commercially available as Silwet L-7200 from OSi Specialites, Inc. of Danbury, Conn. Typically, the surfactant is added to the intercalated flakes at a level of about 0.25 to about 5 pph.

(ADDITIVES) The composition used to form the intumescent coating layer may include the binder, expandable graphite, clay and metal carbonate. The intumescent coating layer can also include other fire retardant additives, such as melamine cyanurate; dual effect additives like melamine pyrophosphate, melamine polyphosphate or ammonium polyphosphate; or minor intumescents like zinc borate or red phosphorous. In addition, the intumescent coating composition can include magnesium oxide (MgO) or alumina trihydrate (ATH). Also, the intumescent coating composition can include a dispersant and/or defoamer.

(DEFOAMER) The defoamer may be one or more selected from the group consisting of silicone based defoamers, mineral oil emulsion based defoamers, and polyolefin based defoamers. For instance, the defoamer may be one or more selected from the group consisting of BYK-028 from BYK, BYK-037 from BYK, BYK-055 from BYK, BYK-057 from BYK, BYK-070 from BYK and BYK-141 from BYK. The defoamer may be in an amount of 0.001 wt. % to 1 wt. % based on the total weight of the composition used to form the intumescent coating layer. (DISPERSANT) Any dispersant can be used so long that it improves the separation of the particles and prevents their settling or clumping. For instance, the dispersant can be one or more selected from DARVAN 7 (R. T. Vanderbilt Company) which is a Sodium salt of polyacrylic acid, DARVAN 811 (R. T. Vanderbilt Company) which is Sodium polyelectrolyte, DARVAN 821A (R. T. Vanderbilt Company) which is Ammonium polyacrylate, DARVAN C (R. T.

Vanderbilt Company) which is Ammonium polymethacrylate, DISPERBYK 190 (BYK-Chemie USA, Inc) which is High molecular weight copolymer, DISPERBYK 191 (BYK-Chemie USA, Inc), DISPERBYK 192 (BYK-Chemie USA, Inc), EDAPLAN™ 492 (MÜNZING CHEMIE), SOLSPERSE 20000 (Avecia, Inc.) which is Polymeric alkoxylate, SOLSPERSE 27000 (Avecia, Inc.) which is Polymeric alkoxylate, SOLSPERSE 38500 (Avecia, Inc.) which is 2-methoxy-1-methethyl acetate, SOLSPERSE 41090 (Avecia, Inc.) which is Polymeric alkoxylate, SOLSPERSE 54000 (Avecia, Inc.) which is Polymeric Dispersant, TEGO DISPERS 740W (Degussa Tego) which is Non-ionic modified fatty acid derivative, TEGO DISPERS 750W (Degussa Tego), and TEGO DISPERS 760W (Degussa Tego). The dispersant can be present in an amount from 0.05 wt. % to 10 wt. %, based on the total weight of the composition used to form the intumescent coating layer.

### Fire Retardant Assembly

The disclosure includes a fire retardant assembly which may comprise the fire retardant overlay disclosed herein bonded to a substrate. The fire retardant overlay can be bonded to the substrate with a fastener. (FASTENER) The fire retardant overlay can be mechanically bonded to the substrate, such as with staples, nails, screws, or the like. Also, the fire retardant overlay can be chemically bonded to the substrate with an adhesive. The adhesive in the fire retardant assembly can have a weight of 10 gsm to 400 gsm, or 50 gsm to 300 gsm, or 100 gsm to 200 gsm.

The adhesive can be a laminating adhesive such as hot-melt adhesives, a thermoplastic polyurethane, a thermoplastic acrylic, a rubber-based adhesive, a polyamide, polyvinyl acetate, a polyethylene-vinyl alcohol copolymer, a polyether-polyamide copolymer such as PEBAX, other solvent-borne adhesives, polyvinyl butyral, cellulosic derivatives such as cellulose-acetate-butyrate, silicone RTV's, or other similar flexible adhesives commonly employed to laminate films or bond plastic materials together. The adhesive may be a solvent borne adhesive of a flexible thermoplastic material, such as a polyurethane, polyamide or acrylic polymer. The adhesive in particular may be a thermoplastic polyurethane adhesive which can be applied as a solution, and re-activated with a solvent such as methyl ethyl ketone applied to the dried adhesive layer.

Preferably, the adhesive can be a two-part adhesive, in which the two or more components are applied separately or as a pre-made mixture to the inner or outer layers that interact to form the adhesive. Examples may include 2 k crosslinked polyurethanes, thermoset acrylic adhesives, epoxies, crosslinked polyureas, polyurethaneureas, two part silicone rubber adhesives, and other commonly employed two component adhesive materials.

(SUBSTRATE) The substrate for the fire retardant assembly can be a panel of plywood, oriented strand board (OSB), medium density fiberboard (MDF), solid wood, member cut from solid wood, mass timber panel, particle board, a metal part, gypsum wall board, or a hybrid thereof. These wood panels can be sanded prior to laminating the overlay to the panel. The sand paper grits can be 40 followed by 60; a 60 followed by 80; or an 80 followed by 120. The panel can have a thickness of 1 mm to 300 mm, 5 mm to 160 mm, 5 mm to 40 mm, or 8 mm to 20 mm. On the other hand, the substrate can be a non-wood substrate, such as a flexible foam layer, gypsum wallboard or a metal panel. These assemblies can be used on telephone poles or as panels in vehicles such as automobiles, trucks, airplanes, etc. as well as all building assemblies. Ideally, the fire retardant assembly has a 1 hr to 2.5 hr fire rating using an ASTM E119 burn test.

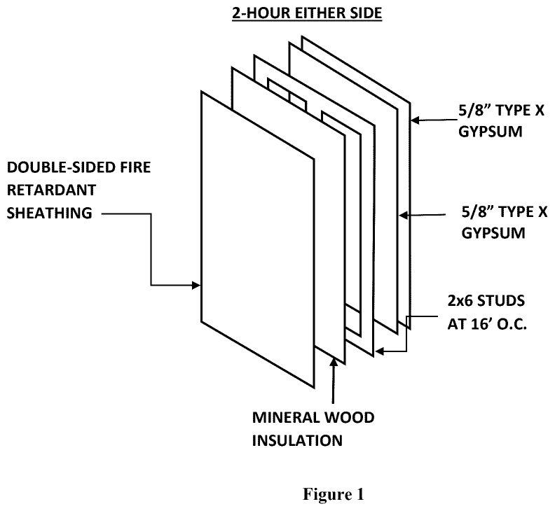

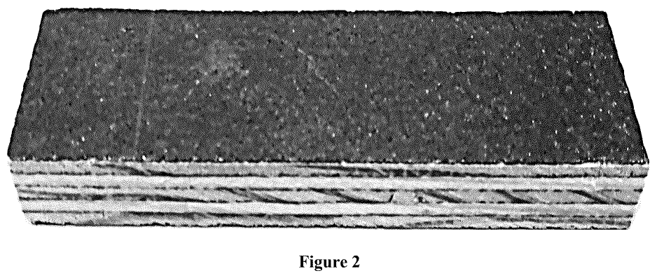

The fire retardant assembly can be used in walls, and may further comprise a drywall layer, structural lumber, and insulation. The fire retardant assembly can be similar to other fire rated wall assemblies used in the construction industry (see FIG. 1). The inside surface of the assembly can have one or two layers of ⅝ ″ thick type X drywall that are fastened to wood studs using screws. The ASTM E-119 burn through rating can increase with the number of drywall layers. A one hour rating can be obtained with one layer while a two hour rating can be obtained with two layers. Standard 2″×4″ stud lumber (or wider than 4″) can form the center of the wall and provide the structural strength although other sized boards are envisioned. The spaces between the studs can be filled with insulation (preferably at least R13 mineral wool or higher). An overlay affixed to a panel can be fastened to opposing side of the studs. Thus, fire retardant assembly can act as a fire barrier from the outside and can act as the sheathing component of the wall, providing shear strength to the assembly. A cladding system can then be applied over the fire retardant assembly panel to protect the outside of the building from the elements. The cladding system can comprise either fiber cement siding or a wood based siding.

The fire retardant assembly comprising the fire retardant overlay can have various structural designs. For instance, the fire retardant assembly can include a substrate which is mass timber; or wherein the substrate is solid sawn wood behind which is the stud cavity and then on the other side of the stud cavity is drywall, OSB, plywood or more tongue and groove solid sawn wood boards; or wherein the substrate is a metal structural member and further comprising a column or metal sheet on the other side.

The use of the fire retardant assembly panel can eliminate the need for a layer of drywall on the outside of the wall assembly between the sheathing and the cladding. This layer of drywall may not be needed for all types of fire retardant assemblies. The elimination of the drywall layer, reduced labor and the dead load on the structure, can result in further cost reduction.

### EXAMPLES

The following examples are illustrative, but not limiting, of the methods and compositions of the present disclosure. Other suitable modifications and adaptations of the variety of conditions and parameters normally encountered in the field, and which are obvious to those skilled in the art, are within the spirit and scope of the disclosure. All patents and publications cited herein are fully incorporated by reference herein in their entirety.

### Testing of Binders for Expandable Graphite Composition

In the intumescent coating layer of the overlay, the expandable graphite has an activation temperature which is higher than the crossover temperature of the polymeric binder in the intumescent coating layer. Different binder compositions were subjected to high-temperatures and eventual decomposition in the absence of expandable graphite to estimate the type of expandable graphite that would be compatible with the binder compositions. The rheological properties of these binders were compared over the temperature region where the graphite undergoes expansion. Without being bound to theory, it would be beneficial for the binder adhering the graphite to fiberglass layer to be able to flow or otherwise deform while the graphite is actively expanding. For example, with a rigid binder capable of withstanding only minimal strain before fracturing, the graphite could separate from the binder during expansion, potentially resulting in a weaker intumescent. However, if the binder instead exhibits viscous, liquid-like behavior throughout the temperature region that the graphite expands, then it is theoretically possible for some encapsulation of the expanded graphite flakes to occur, thereby potentially resulting in a more durable char.

A self crosslinking acrylic ester/vinylidene chloride copolymer emulsion was found to have a liquid-like transition occurring over a fairly narrow temperature window of 224 °C 260 °C, i.e., the copolymer had a crossover temperature of 224 °C. On the other hand, a polyvinyl acrylic/vinyl versatate binder resin was found to have a broader window of about 91 °C-300 °C, and as such, the crossover temperature was 91 °C. This polyvinyl acrylic/vinyl versatate binder resin affords more flexibility in being able to choose from a broader variety of graphites based on their individual onset temperatures when compared to the self crosslinking acrylic ester/vinylidene chloride copolymer emulsion.

A vinyl acetate ethylene acrylate binder and a vinyl acetate ethylene vinyl chloride binder were tested. Although these binders did not give truly liquid-like flow, they were found to behave as low modulus, rubbery gel-like materials and could possibly deform sufficiently to match the graphite's expansion.

Hycar NH 3069 (an acrylic polymer) had fairly high moduli and small loss tangents in the relevant decomposition window. It is unclear if this binder would be unable to strain sufficiently to match the graphite's expansion, since it would certainly add stress opposing the expansion of the graphite. As such, this binder would be more likely to result in separation of the graphite. On the other hand, Hycar NH 3069 was not completely reduced to white ash after testing to 600 °C, but instead remained as a black, carbonaceous char. While this resistance to ashing is desirable, the high modulus over the graphite decomposition window likely limits the ability to adhere to the graphite after expansion.

### Inventive Example 1

A commercial fiberglass mat comprising nonwoven glass fibers and an at least partially cured polymeric binder was selected. A polymeric binder composition was applied to one side (hereinafter referred to as the bottom side) of the mat. This filler composition comprised an aqueous composition of styrene acrylic resin, clay, and metal carbonate. The solvent was driven off and the resin cured to a green strength at >100 °C. The treated mat had a higher concentration of total polymeric binder in the bottom half than the top half.

The intumescent coating was prepared in an aqueous solvent and contained 10 wt. %-25 wt. % of 80-130 mesh expandable graphite having an onset temperature of 180 °C-270 °C, 9 wt. %-20 wt. % ammonium polyphosphate (APP) type 2 which acts as a charring agent, 3 wt. %-25 wt. % polyvinyl acrylic/vinyl versatate binder resin, and 3 wt. %-15 wt. % zinc borate as a chemical graphite anchor. A dispersant and defoamer were added as processing aids. The weight percent values are based on the dry weight of the intumescent coating. The intumescent coating was applied as a liquid to the unfilled side of the filled fiberglass mat using a slot die coater.

Once applied the coating was cured in a series of hot air flotation driers. The final overlay was black with a grey/white underside and was flexible.

### Inventive Example 2

The process of forming the overlay of inventive example 1 was essentially repeated except the intumescent coating was prepared with a polymer dispersion produced from monomers of vinyl acetate, ethylene, and acrylate (Vinnapas EAF 68) rather than polyvinyl acrylic/vinyl versatate.

### Comparative Example 1

The process of forming the overlay of inventive example 1 was essentially repeated, except the filler composition comprising an aqueous composition of styrene acrylic resin, clay, and metal carbonate was applied to the top side of the glass mat. The solvent was driven off and the resin cured to a green strength at >100 °C. The treated mat had a higher concentration of total polymeric binder in the top half than the bottom half.

The intumescent coating composition in liquid form was also applied to the top side (i.e., the filled side) of the partially filled fiberglass mat using a slot die coater. Once applied the coating was cured in a series of hot air flotation driers.

The intumescent coating composition was applied at a coating weight of about 280 gsm.

### Comparative Example 2 The process of forming the overlay of comparative example 1 was essentially repeated.

Similar to Comparative Example 1, the filler composition and the intumescent coating composition were applied to the same side of the mat, i.e., the top side. The intumescent coating composition was applied at a coating weight of about 250 gsm.

### Comparative Example 3—No Expandable Graphite

The process of forming the overlay of comparative example 1 was essentially repeated, except the intumescent coating composition was prepared with ammonium polyphosphate (APP), melamine monomer and a sucrose based blowing agent. Similar to Comparative Example 1, the filler composition and the intumescent coating composition were applied to the same side of the mat, i.e., the top side. The intumescent coating composition was applied at a coating weight of about 190 gsm.

### Fire Retardancy

The bottom of the overlay was attached to a substrate with a 2 k polyurethane adhesive. A thermocouple was embedded between the overlay and the substrate.

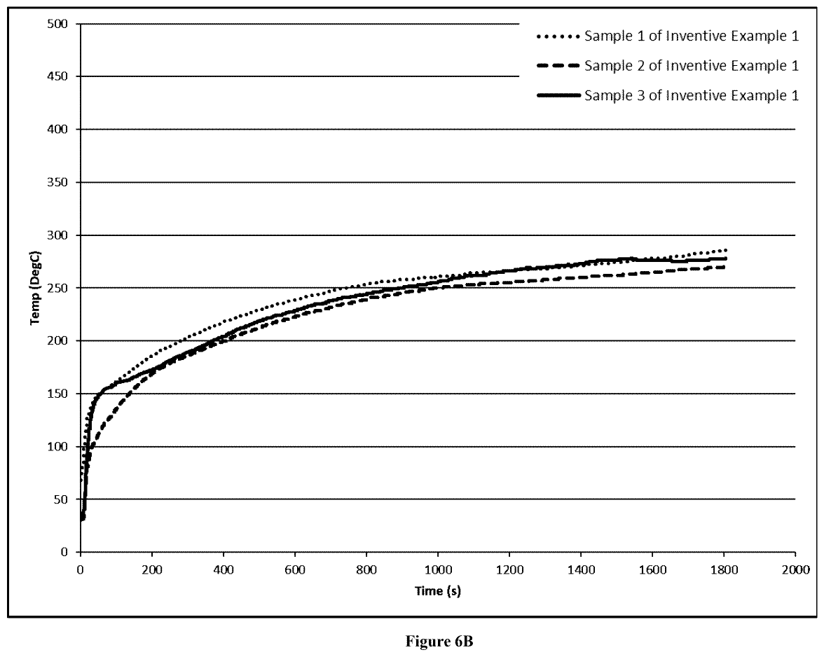

The panels were tested in accordance with a modified 2 Foot Tunnel Method of ASTM D3806-98 (Reapproved 2011). This test also includes a method for measuring the flame spread rating, which is not used herein since the substrate does not ignite during the test. Herein, the resistance to temperature rise through the overlay was measured. The test method of ASTM D3806-98 (Reapproved 2011) was generally followed to measure the resistance to increased temperatures through the overlay with the following modifications. A standard laboratory Bunsen burner was used with propane gas as the fuel. Ignition was achieved using a handheld wand butane spark igniter. (See section 4.2 of ASTM D3806-98 (Reapproved 2011)) Propane gas flow was controlled with an inline flow meter set to 40 ml/s (see section 4.4). Neither a cement board nor a steel plate were used on top of the test specimen (see section 4.5). A standard k type thermocouple was embedded at the substrate-overlay interface and the temperature was recorded every 1 second for the duration of the test and the timer was visually monitored (see sections 4.6-4.8). Aspen OSB and Douglas Fir plywood panels purchased at a local hardware store were used for a majority of testing. Panels were typically not planed, sanded, or otherwise refined from the purchased state prior to testing. Moisture content of test panel was not monitored. Also, the ends of the test boards were not varnished (see section 5.1). Section 7 was modified, i.e., a wet coating was not applied directly to the substrate, and the overlay is laminated with an adhesive to the substrate. The properties of the overlay (coating weight and moisture content) were measured prior to being laminated to the substrate. The test is run for 30 min. The change in temperature at the thermocouple was recorded to give the thermogram of FIG. 6A.

The data in FIG. 6A shows the fire retardancy of Comparative Examples 1-3 that are not prepared according to the invention. These comparative overlays were prepared with the intumescent coating composition being applied to the same side of the fiberglass layer as the filler composition comprising clay and calcium carbonate. These comparative overlays had low fire retardancy and showed a significant amount of heat transferred to the back of the substrate. Three separate overlay samples made in accordance with the process described above for Inventive Example 1 of the present disclosure were prepared. The bottom of each overlay was attached to a substrate with a 2 k polyurethane adhesive. A thermocouple was embedded between each overlay and the substrates. Using 2' tunnel burn conditions as described above, the change in temperature at the thermocouple was recorded to give the thermogram of FIG. 6B.

FIG. 6B shows that the overlays of the present disclosure each gave excellent fire retardancy. The data in FIG. 6B shows the fire retardancy of three separate overlay samples made in accordance with the process described above for Inventive Example 1. These inventive overlays were prepared with the intumescent coating composition being applied to the opposite side of the fiberglass layer as the filler composition comprising clay and calcium carbonate. These inventive overlays had excellent fire retardancy and were found to block a significant amount of heat from transferring to the back of the substrate.

Upon comparing the thermograms of the comparative overlays in FIG. 6A with the thermograms of the inventive overlays from FIG. 6B, it is clear that overlays of the present disclosure had better fire retardancy than the comparative overlays. The overlays of the present disclosure were prepared with the intumescent coating composition applied to the opposite side of the fiberglass layer from the side that the filler composition comprising clay and calcium carbonate was applied. As shown in FIG. 3, the intumescent coating composition was able to partially penetrate the fiberglass layer when the intumescent coating composition was applied to the opposite side of the fiberglass layer from the side that the filler composition comprising clay and calcium carbonate was applied. Theoretically, this allows for better adhesion of the intumescent coating composition to the fiberglass layer thereby reducing the amount of the intumescent coating that separates from the fiberglass layer during exposure to high temperatures.

### Comparative Example 4

The process of forming the overlay of inventive example 1 was essentially repeated except the commercial fiberglass sheet was not further filled by applying the binder composition comprising the clay and metal carbonate to the fiberglass sheet. Instead the fiberglass sheet was impregnated from both sides and throughout its thickness with the intumescent coating composition, the resulting overlay was applied to a wood panel. When exposed to a flame, the intumescent coating was constrained and prevented from expanding. As such, the overlay did not act as an insulating layer and did not protect the wood panel.

Other embodiments of the present disclosure will be apparent to those skilled in the art from consideration of the specification and practice of the embodiments disclosed herein. As used throughout the specification and claims, “a” and/or “an” and/or “the” may refer to one or more than one. Unless otherwise indicated, all numbers expressing quantities, proportions, percentages, or other numerical values are to be understood as being modified in all instances by the term “about.” Accordingly, unless indicated to the contrary, the numerical parameters set forth in the specification and claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is to be understood that each component, compound, substituent or parameter disclosed herein is to be interpreted as being disclosed for use alone or in combination with one or more of each and every other component, compound, substituent or parameter disclosed herein.

It is further understood that each range disclosed herein is to be interpreted as a disclosure of each specific value within the disclosed range that has the same number of significant digits. Thus, for example, a range from 1-4 is to be interpreted as an express disclosure of the values 1, 2, 3 and 4 as well as any range of such values.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range. That is, it is also further understood that any range between the endpoint values within the broad range is also discussed herein. Thus, a range from 1 to 4 also means a range from 1 to 3, 1 to 2, 2 to 4, 2 to 3, and so forth.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

### CLAIMS

1. A fire retardant overlay for use in providing fire resistance to a substrate, said overlay comprising:
an intumescent coating layer comprising at least one expandable graphite and at least one polymeric binder,
a fiberglass layer comprising at least one polymeric binder, said polymeric binder of the intumescent coating layer may be the same or different from the polymeric binder of the fiberglass layer, said overlay having the following feature(s) (A) and/or (B):
   (A) wherein the expandable graphite has an activation temperature which is higher than the crossover temperature of the polymeric binder in the intumescent coating layer; and/or
   (B) said fiberglass layer having a bottom half and a top half, and the bottom half has a higher concentration of polymeric binder than the top half, wherein the intumescent coating layer is in contact with the top half of the fiberglass layer.
2. A method of forming a fire retardant overlay, said overlay comprising:
an intumescent coating layer comprising at least one expandable graphite and at least one polymeric binder,
a fiberglass layer comprising at least one polymeric binder,
said polymeric binder of the intumescent coating layer may be the same or different from the polymeric binder of the fiberglass layer,
said method comprising the following feature(s) (A) and/or (B)
   (A) a step of combining an expandable graphite having an activation temperature which is higher than the crossover temperature of the polymeric binder in the intumescent coating layer; and/or
   (B) said fiberglass layer having a bottom half and a top half, and filling a fiberglass sheet from a bottom surface to form the fiberglass layer so that the bottom half of the fiberglass layer has a higher concentration of the total polymeric binder than the top half, applying an intumescent coating composition to a top surface of the fiberglass layer so that the intumescent coating layer is in contact with the top half of the fiberglass layer.
3. The fire retardant overlay or method as described in any one of the previous claims, wherein the polymeric binder of the intumescent coating layer is a vinyl polymer selected from the group consisting of vinyl acrylics, butyl, copolymers of acrylic acid ester and styrene, vinyl acetate, vinyl acrylic-vinyl versatate, vinyl acetate-vinyl versatate, polyvinylchloride-acrylic copolymers, carboxylated vinylidene chloride, polyvinylidene chloride acrylic copolymers, vinylchloride-ethylene, acrylate-acrylonitrile, and mixtures thereof; or the vinyl polymer is styrenated acrylates, vinyl acrylic-vinyl versatate, and vinyl acetate-vinyl versatate.
4. The fire retardant overlay or method as described in any one of the previous claims, wherein the vinyl polymer is present in the intumescent coating layer in an amount to provide at least 1 wt. %, or 1 wt. % to 40 wt. %, or 3 wt. % to 25 wt. %, or 10 wt. % to 20 wt. % based on a total dry weight of the intumescent coating layer.
5. The fire retardant overlay or method as described in any one of the previous claims, wherein the intumescent coating layer further comprises a boron-containing compound; or wherein the boron-containing compound may be selected from the group consisting of a barium borate, barium metaborate, zinc borate or zinc metaborate.
6. The fire retardant overlay or method as described in any one of the previous claims, wherein the intumescent coating layer further comprises a boron-containing compound present in an amount to provide a boron concentration in a range of greater than 0 wt. % to 2 wt. % based on total dry weight of the intumescent coating layer.
7. The fire retardant overlay or method as described in any one of the previous claims, wherein the intumescent coating layer further comprises a boron-containing compound in a concentration of at least 0.1 wt. %, or 3 wt. % to 15 wt. %, or 6 wt. % to 9 wt. % based on the total dry weight of the intumescent coating layer.
8. The fire retardant overlay or method as described in any one of the previous claims, wherein the intumescent coating layer further comprises a charring agent; or a charring agent comprising a phosphorous-containing compound; or a charring agent comprising an ammonium phosphate, amine phosphate, melamine phosphate, triphenyl phosphate, monoammonium phosphate, ammonium polyphosphate, and combinations thereof; or a charring agent which is ammonium polyphosphate (APP).
9. The fire retardant overlay or method as described in any one of the previous claims, wherein the intumescent coating layer further comprises a phosphorous-containing compound in an amount of 1 wt. %-30 wt. %; or 5 wt. %-23 wt. %; or 9 wt. %-13 wt. % based on the dry weight of the intumescent coating layer.
10. The fire retardant overlay or method as described in any one of the previous claims, wherein the expandable graphite has a mean or average size, expressed as the D50, in the range from about 30 μm to about 1.5 mm, or from about 50 μm to about 1.0 mm, or from about 180 μm to about 850 μm, or at least 30 μm, or at least 44 μm, or at least 180 μm, or at least 300 μm, or at most 1.5 mm, or at most 1.0 mm, or at most 850 μm, or at most 600 μm, or at most 500 μm, or at most 400 μm. 11. The fire retardant overlay or method as described in any one of the previous claims, wherein the expandable graphite has a particle size of 32 mesh, 50 mesh, 80 mesh, 100 mesh, 150 mesh, -100 mesh, -200 mesh, -325 mesh or mixtures thereof.
12. £ The fire retardant overlay or method as described in any one of the previous claims, wherein there are two or more expandable graphites in the intumescent coating layer; or wherein the expandable graphite has a temperature of activation in the range of 165 °C to 300 °C, or 180 °C to 300 °C, or in the range of 190 °C to 260 °C, or in the range of 200 °C to 220 °C.
13. The fire retardant overlay or method as described in any one of the previous claims, wherein the expandable graphite is in a concentration of at least 10 wt. %, or 10 wt. % to 25 wt. %, or 19 wt. % to 23 wt. % based on the total dry weight of the intumescent coating layer.
14. The fire retardant overlay or method as described in any one of the previous claims, wherein the intumescent layer has a thickness of up to 1.50 mm, or up to 1.00 mm, or 0.1 mm to 1.50 mm, or 0.1 mm to 1.00 mm, or less than 0.7 mm, or 0.3 mm to 0.6 mm, or 0.4 mm to 0.55 mm; and the fiberglass layer has a thickness of less than 0.5 mm, or 0.2 mm to 0.5 mm, or 0.25 mm to 0.4 mm; or wherein the thickness of the intumescent layer is at least 50 microns thicker than the fiberglass layer.
15. The fire retardant overlay or method as described in any one of the previous claims, wherein the fiberglass layer is formed from a fiberglass sheet, fiberglass mat, scrim, loose weaves or fiberglass mesh comprising a plurality of nonwoven glass fibers and a composition comprising a binder, and said composition is at least partially cured.
16. The fire retardant overlay or method as described in any one of the previous claims, wherein the binder for the fiberglass layer is selected from polyvinyl resins or condensation-polymers; or polyvinyl acetate, polyvinyl butyral, polyvinyl alcohol, polystyrene resins; acrylic ester resins and methacrylic ester resins, phenol-aldehydes, urea-aldehydes, melamine-aldehydes, and condensation-polymers of furan or polyurethane resins; or styrene acrylic resins, cyanoacrylates, polyisobutylene polyamide, carlonidene polymers (Coarmarone-idene polymers), silicone synthetic resins; or urea formaldehyde resin or an acrylic resin.
17. The fire retardant overlay or method as described in any one of the previous claims, wherein the binder for the fiberglass layer is present in an amount of less than 15 wt. %, or 1 wt. % to 12 wt. %, or 3 wt. % to 10 wt. % based on the total weight of the fiberglass layer.
18. The fire retardant overlay or method as described in any one of the previous claims, wherein the fiberglass layer comprises clay selected from montmorillonite clay, vermiculite, mica, talc, bentonite clay, kaolin clay, zeolite, china clay and mixtures thereof.
19. The fire retardant overlay or method as described in any one of the previous claims, wherein the fiberglass layer comprises a metal carbonate; or, wherein the metal carbonate may be selected from the group consisting of sodium carbonate, potassium carbonate, magnesium carbonate or calcium carbonate.
20. The fire retardant overlay or method as described in any one of the previous claims, wherein the bottom half of the fiberglass layer has more types of clay than the top half.
21. The fire retardant overlay or method as described in any one of the previous claims, wherein the bottom half of the fiberglass layer has more types of metal carbonate than the top half.
22. The fire retardant overlay or method as described in any one of the previous claims, wherein the bottom half of the fiberglass layer has a concentration of total polymeric binder which is at least 0.1 wt. %, or at least 0.5 wt. % or at least 1 wt. % higher than the top half, based on the total weight of the fiberglass layer.
23. The fire retardant overlay or method as described in any one of the previous claims, wherein the bottom half of the fiberglass layer has a concentration of clay and/or metal carbonate which is at least 0.1 wt. %, or at least 0.5 wt. % or at least 1 wt. % higher than the top half, based on the total weight of the fiberglass layer.
24. The fire retardant overlay or method as described in any one of the previous claims, wherein the fiberglass layer comprises clay present in an amount of at least 5 wt. %, or 5 wt. % to 40 wt. %, or 10 wt. % to 35 wt. %, or 15 wt. % to 30 wt. % based on the total dry weight of fiberglass layer.
25. The fire retardant overlay or method as described in any one of the previous claims, wherein the fiberglass layer comprises metal carbonate present in an amount of at least 5 wt. %, or 5 wt. % to 80 wt. %, or 20 wt. % to 75 wt. %, or 35 wt. % to 65 wt. % based on the total dry weight of the fiberglass layer.
26. The fire retardant overlay or method as described in any one of the previous claims, wherein the intumescent coating layer is formed from an intumescent coating composition and a portion of the intumescent coating composition penetrates the upper half of the fiberglass layer when the intumescent coating composition is applied.
27. The fire retardant overlay or method as described in any one of the previous claims, wherein the total weight of the fiberglass layer has increased to 575 wt. % and 800 wt. % of its original weight after the fiberglass layer has been filled from the bottom surface with the polymeric binder and optionally clay and metal carbonate, and has a Gurley porosity of greater than 300 seconds/300 cm³ of air using ISO test method 5636-5.
28. The fire retardant overlay or method as described in any one of the previous claims, wherein the fiberglass layer which has been filled from the bottom surface has a dry weight of 300 gsm to 700 gsm, or 350 gsm to 650 gsm, or 420 gsm to 600 gsm.
29. The fire retardant overlay or method as described in any one of the previous claims, wherein the overlay has a dry weight of 300 gsm to 1500 gsm, or 400 gsm to 1000 gsm, or 600 gsm to 900 gsm.
30. The fire retardant overlay or method as described in any one of the previous claims, wherein the fiberglass layer has glass fibers essentially continuously spread throughout the length and width of the fiberglass layer; or wherein the fiberglass layer comprises nonwoven glass fibers.
31. The fire retardant overlay or method as described in any one of the previous claims, wherein the intumescent coating layer has a top surface which is black.
32. A fire retardant assembly comprising the fire retardant overlay of any one of the previous claims bonded to a substrate.
33. The fire retardant assembly as described in any one of the previous claims, wherein the fire retardant overlay is bonded to the substrate with a fastener.
34. The fire retardant assembly as described in any one of the previous claims, wherein the fastener is a mechanical fastener, such as staples, nails, screws, or the like; or the fastener is a chemical fastener, such as an adhesive, or wherein the fastener is an adhesive having a weight of 10 gsm to 400 gsm, or 50 gsm to 300 gsm, or 100 gsm to 200 gsm.
35. The fire retardant assembly as described in any one of the previous claims, wherein the substrate is a panel of plywood, oriented strand board (OSB), medium density fiberboard (MDF), solid wood, member cut from solid wood, mass timber panel, particle board, a metal part, gypsum wall board, or a hybrid thereof.
36. The fire retardant assembly as described in any one of the previous claims, wherein the substrate is a panel having a thickness of 1 mm to 300 mm, 5 mm to 160 mm, 5 to 40 mm, or 8 to 20 mm.
37. The fire retardant assembly as described in any one of the previous claims, wherein the fire retardant assembly has a 1 hr to 2.5 hr fire rating using an ASTM E119 wall burn test.
38. The fire retardant assembly as described in any one of the previous claims, wherein the substrate is a wood panel, and further comprising a drywall layer, structural lumber, and insulation; or wherein the substrate is mass timber; or wherein the substrate is solid sawn wood behind which is the stud cavity and then on the other side of the stud cavity is drywall, OSB, plywood or more tongue and groove solid sawn wood boards; or wherein the substrate is a metal structural member and further comprising a column or metal sheet on the other side.

1. A fire retardant overlay for use in providing fire resistance to a substrate, said overlay comprising:
an intumescent coating layer comprising at least one expandable graphite and at least one polymeric binder,
a fiberglass layer comprising at least one polymeric binder,
said polymeric binder of the intumescent coating layer may be the same or different from the polymeric binder of the fiberglass layer, said overlay having the following feature(s) (A) and/or (B):
(A) wherein the expandable graphite has an activation temperature which is higher than the crossover temperature of the polymeric binder in the intumescent coating layer; and/or
(B) said fiberglass layer having a bottom half and a top half, and the bottom half has a higher concentration of polymeric binder than the top half, wherein the intumescent coating layer is in contact with the top half of the fiberglass layer.

2. A method of forming a fire retardant overlay, said overlay comprising:
an intumescent coating layer comprising at least one expandable graphite and at least one polymeric binder,
a fiberglass layer comprising at least one polymeric binder,
said polymeric binder of the intumescent coating layer may be the same or different from the polymeric binder of the fiberglass layer,
said method comprising the following feature(s) (A) and/or (B)
(A) a step of combining an expandable graphite having an activation temperature which is higher than the crossover temperature of the polymeric binder in the intumescent coating layer; and/or
(B) said fiberglass layer having a bottom half and a top half, and filling a fiberglass sheet from a bottom surface to form the fiberglass layer so that the bottom half of the fiberglass layer has a higher concentration of the total polymeric binder than the top half, applying an intumescent coating composition to a top surface of the fiberglass layer so that the intumescent coating layer is in contact with the top half of the fiberglass layer.

3. The method of claim 2, wherein the polymeric binder of the intumescent coating layer is a vinyl polymer selected from the group consisting of vinyl acrylics, butyl, copolymers of acrylic acid ester and styrene, vinyl acetate, vinyl acrylic-vinyl versatate, vinyl acetate-vinyl versatate, polyvinylchloride-acrylic copolymers, carboxylated vinylidene chloride, polyvinylidene chloride acrylic copolymers, vinylchloride-ethylene, acrylate-acrylonitrile, and mixtures thereof; or the vinyl polymer is styrenated acrylates, vinyl acrylic-vinyl versatate, and vinyl acetate-vinyl versatate.

4. The method of claim 2, wherein the vinyl polymer is present in the intumescent coating layer in an amount to provide at least 1 wt. %, or 1 wt. % to 40 wt. %, or 3 wt. % to 25 wt. %, or 10 wt. % to 20 wt. % based on a total dry weight of the intumescent coating layer.

5. The method of claim 2, wherein the intumescent coating layer further comprises a boron-containing compound; or wherein the boron-containing compound may be selected from the group consisting of a barium borate, barium metaborate, zinc borate or zinc metaborate.

6. The method of claim 2, wherein the intumescent coating layer further comprises a boron-containing compound present in an amount to provide a boron concentration in a range of greater than 0 wt. % to 2 wt. % based on total dry weight of the intumescent coating layer.

7. The method of claim 2, wherein the intumescent coating layer further comprises a boron-containing compound in a concentration of at least 0.1 wt. %, or 3 wt. % to 15 wt. %, or 6 wt. % to 9 wt. % based on the total dry weight of the intumescent coating layer.

8. The method of claim 2, wherein the intumescent coating layer further comprises a charring agent; or a charring agent comprising a phosphorous-containing compound; or a charring agent comprising an ammonium phosphate, amine phosphate, melamine phosphate, triphenyl phosphate, monoammonium phosphate, ammonium polyphosphate, and combinations thereof, or a charring agent which is ammonium polyphosphate (APP).

9. The method previous of claim 2, wherein the intumescent coating layer further comprises a phosphorous-containing compound in an amount of 1 wt. %-30 wt. %; or 5 wt. %-23 wt. %; or 9 wt. %-13 wt. % based on the dry weight of the intumescent coating layer.

10. The method of claim 2, wherein the expandable graphite has a mean or average size, expressed as the D 50, in the range from about 30 μm to about 1.5 mm, or from about 50 μm to about 1.0 mm, or from about 180 μm to about 850 μm, or at least 30 μm, or at least 44 μm, or at least 180 μm, or at least 300 μm, or at most 1.5 mm, or at most 1.0 mm, or at most 850 μm, or at most 600 μm, or at most 500 μm, or at most 400 μm.

11. The method of claim 2, wherein the expandable graphite has a particle size of 32 mesh, 50 mesh, 80 mesh, 100 mesh, 150 mesh, -100 mesh, -200 mesh, -325 mesh or mixtures thereof.

12. The method of claim 2, wherein there are two or more expandable graphites in the intumescent coating layer; or wherein the expandable graphite has a temperature of activation in the range of 165 °C to 300 °C, or 180 °C to 300 °C, or in the range of 190 °C to 260 °C, or in the range of 200 °C to 220 °C.

13. The method of claim 2, wherein the expandable graphite is in a concentration of at least 10 wt. %, or 10 wt. % to 25 wt. %, or 19 wt. % to 23 wt. % based on the total dry weight of the intumescent coating layer.

14. The method of claim 2, wherein the intumescent layer has a thickness of up to 1.50 mm, or up to 1.00 mm, or 0.1 mm to 1.50 mm, or 0.1 mm to 1.00 mm, or less than 0.7 mm, or 0.3 mm to 0.6 mm, or 0.4 mm to 0.55 mm; and the fiberglass layer has a thickness of less than 0.5 mm, or 0.2 mm to 0.5 mm, or 0.25 mm to 0.4mm; or wherein the thickness of the intumescent layer is at least 50 microns thicker than the fiberglass layer.

15. The method of claim 2, wherein the fiberglass layer is formed from a fiberglass sheet, fiberglass mat, scrim, loose weaves or fiberglass mesh comprising a plurality of nonwoven glass fibers and a composition comprising a binder, and said composition is at least partially cured.

16. The method of claim 2, wherein the binder for the fiberglass layer is selected from polyvinyl resins or condensation-polymers; or polyvinyl acetate, polyvinyl butyral, polyvinyl alcohol, polystyrene resins; acrylic ester resins and methacrylic ester resins, phenol-aldehydes, urea-aldehydes, melamine-aldehydes, and condensation-polymers of furan or polyurethane resins; or styrene acrylic resins, cyanoacrylates, polyisobutylene polyamide, carlonidene polymers (Coarmarone-idene polymers), silicone synthetic resins; or urea formaldehyde resin or an acrylic resin.

17. The method of claim 2, wherein the binder for the fiberglass layer is present in an amount of less than 15 wt. %, or 1 wt. % to 12 wt. %, or 3 wt. % to 10 wt. % based on the total weight of the fiberglass layer.

18. The method of claim 2, wherein the fiberglass layer comprises clay selected from montmorillonite clay, vermiculite, mica, talc, bentonite clay, kaolin clay, zeolite, china clay and mixtures thereof.

19. The method of claim 2, wherein the fiberglass layer comprises a metal carbonate; or, wherein the metal carbonate may be selected from the group consisting of sodium carbonate, potassium carbonate, magnesium carbonate or calcium carbonate.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A fire retardant assembly comprising the fire retardant overlay of claim 1 bonded to a substrate.

33. (canceled)

34. (canceled)

35. (canceled)

36. (canceled)

37. (canceled)

38. (canceled)
